(19) United States
(12) Patent Application Publication
(10) Pub. No.: US 2003/0044221 A1
(43) Pub. Date: Mar. 6, 2003

(54) Binder device with linked arches

(76) Inventors: Chun Yuen To, Kauto Shan Shatin (CN); Chun Hai Lin, Zhang Zhou City (CN)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/943,368

(22) Filed: Aug. 30, 2001

(51) Int. Cl. B42F 3/04

(52) U.S. Cl. 402/41

(57) ABSTRACT

A binder mechanism for retaining loose leaf pages. The mechanism includes a base and three retaining members secured to the base. Each retaining member has a post in fixed position relative to the base and an arch section moveable between a closed position wherein each retaining member forms a substantially continuous, closed loop and an open position wherein each retaining member forms a discontinuous, open loop. The arch sections are linked together for simultaneous movement. A lever is pivotally mounted on the base for actuating movement, and a linkage is provided for transferring force applied by the lever to the retaining members. Substantially equal clamping force is applied to each of the retaining members.

### BACKGROUND OF THE INVENTION

This invention relates to binders for holding loose leaf pages, and in particular to a binder having arch-shaped retaining members which are linked together for simultaneous opening and closing.

A lever arch binder retains loose leaf pages, such as hole-punched papers, in a file or notebook. It features retaining members which are shaped in arched loops and which may be selectively opened to add or remove papers, or closed to retain papers. A lever is provided for moving the retaining members between the open and closed positions. Each retaining member includes an arch section and a post, which is preferably straight to facilitate adding or removing a large stack of papers without the awkwardness inherent in performing that task if the post were curved.

An exemplary lever arch binder is disclosed in European Patent Publication No. EP0962336, which is hereby incorporated by reference. The binder shown in that application has two retaining members for holding papers having two punched holes. Both of the arch sections open and close together, being integrally formed from a single shaft. A central portion of that shaft, between the arches, is pivotally held to a base and functions as a crank for rotating the shaft and moving the arch sections between open and closed positions. Controlled rotation of the shaft is accomplished by a lever and an opposing spring, which each apply force to the central portion of the shaft. The spring is mounted on the base.

One key to effective operation of a lever arch binder is strong and evenly distributed forces for clamping the arches against the post at the closed position and for moving the arches to the open position. That requires application of force at a position which is centrally located and in close proximity to each retaining member. Accordingly, both the lever and the spring shown in EP0962336 engage the central portion of the shaft at a position midway between the two arch sections and in close proximity to each, for providing strong and equally distributed clamping force in both retaining members.

### SUMMARY OF THE INVENTION

Among the several objects and features of the present invention may be noted the provision of a lever arch binder mechanism having three retaining members; the provision of such a mechanism wherein the retaining members are linked together for simultaneous movement; the provision of such a mechanism which applies substantially equal clamping force in each retaining member; the provision of such a mechanism which inhibits structural deformations; and the provision of such a mechanism which is economical.

Generally, a binder mechanism according to the present invention retains loose leaf pages. The mechanism comprises a base and at least three retaining members secured to the base for holding the loose leaf pages. The retaining members are moveable between a closed position wherein each retaining member forms a substantially continuous, closed loop for allowing loose leaf pages retained by the retaining members to be moved along the retaining members, and an open position wherein each retaining member forms a discontinuous, open loop suitable for adding or removing loose leaf pages. A shaft is mounted on the base for pivoting about a pivot axis and mounting the retaining members for moving the retaining members between the closed and open positions. The shaft has a first segment and a second segment. A control controllably pivots the shaft between the open and closed positions, the control applying a force to the first segment via engagement with the first segment and applying a force to the second segment via engagement with the second segment.

In another aspect, a binder mechanism of the present invention comprises an elongate base having a width defined by two generally opposite longitudinal edges. A plurality of retaining members are secured to the base for holding the loose leaf pages, the retaining members being moveable between a closed position wherein each retaining member forms a continuous, closed loop for allowing loose leaf pages retained by the retaining members to be moved along the retaining members, and an open position wherein each retaining member forms a discontinuous, open loop suitable for adding or removing loose leaf pages. A shaft is mounted on the base for pivoting about a pivot axis and mounting the retaining members for moving the retaining members between the closed and open positions. The shaft has at least one crank portion which is spaced from the pivot axis. A spring resiliently transmits force between the base and the crank portion of the shaft and biases the retaining members to the open position. The spring is mounted on the base at a location generally midway between the opposite longitudinal edges of the base whereby force is applied generally symmetrically relative to the width to thereby inhibit structural deformation of the base.

In still another aspect, a binder mechanism according to the present invention comprises a base and at least three retaining members secured to the base for holding loose leaf pages. The retaining members each have a post in fixed position relative to the base and an arch section moveable relative to the base between a closed position wherein each retaining member forms a substantially continuous, closed loop for allowing loose leaf pages retained by the retaining members to be moved along the retaining members, and an open position wherein each retaining member forms a discontinuous, open loop suitable for adding or removing loose leaf pages. A shaft is mounted on the base for pivoting about a pivot axis and mounting the arch sections for moving the arch sections between the closed and open positions. The shaft has a first segment and a second segment, each segment being positioned between a respective pair of retaining members and each having a crank portion which is spaced from the pivot axis of the shaft. A lever is pivotally mounted on the base for actuating movement of the shaft. A linkage is operatively connected to the lever and in engagement with the crank portions of the shaft for transferring force applied by the lever to the first and second segments of the shaft. The linkage has first and second slots formed at opposite ends of the linkage, the crank portions of the first and second segments being slidably captured in respective slots. A spring biases the arch sections to the open position, the spring being mounted on the base at a position generally midway between the crank portions of the first and second segments and configured to engage the linkage.

In yet a further aspect, a method according to the present invention links a third retaining member to a binder mechanism having first and second retaining members for holding loose leaf pages. The mechanism has a base and a shaft mounted on the base for pivoting about a pivot axis, each of the first and second retaining members having a post secured to the base and an arch section secured to the shaft. The arch sections are moveable between a closed position wherein each arch section clamps against the corresponding post and the retaining member forms a continuous, closed loop, and an open position wherein each arch section is spaced from the corresponding post and the retaining member forms a discontinuous, open loop. The method comprises the steps of attaching an arch section of the third retaining member to the shaft at a location along the pivot axis and between the first and second retaining members, and attaching a post of the third retaining member to the base at a position corresponding with the arch section of the third retaining member. Substantially equal torques are applied to the shaft at two locations on the shaft and thereby pivoting the shaft and simultaneously moving the first, second, and third arch sections between the open and closed positions. The locations are spaced on opposite sides of the third retaining member and arranged between the first and second retaining members such that application of the torques distributes substantially equal forces among first, second, and third retaining members for clamping and opening the arch sections.

Other objects and features of the present invention will be in part apparent and in part pointed out hereinafter.

### BRIEF DESCRIPTION OF THE DRAWINGS

FIG. 1 is a right side perspective of a binder mechanism according to the present invention having retaining members in a closed position;

FIG. 2 is a right side perspective of the mechanism of FIG. 1 having retaining members in an open position;

FIG. 3 is a left side perspective of the mechanism of FIG. 1;

FIG. 4 is an exploded perspective of the mechanism of FIG. 1;

FIGS. 5, 6, and 7 are side elevation, end elevation, and top plan views, respectively, of the mechanism of FIG. 1;

FIG. 8 is a perspective of a notebook having the binder mechanism of FIG. 1 and containing loose leaf pages;

FIG. 9 is a right side perspective of a binder mechanism according to a second embodiment of the present invention having wide retaining members with an inwardly slanted post;

FIG. 10 is an end elevation of the mechanism of FIG. 9;

FIG. 11 is a right side perspective of a binder mechanism according to a third embodiment having retaining members with an outwardly slanted post;

FIG. 12 is an end elevation of the mechanism of FIG. 11;

FIG. 13 is a right side perspective of a binder mechanism according to a fourth embodiment having a leaf-type central spring and retaining members with outwardly slanted posts; and

FIG. 14 is an exploded perspective of the mechanism of FIG. 13.

Corresponding reference characters indicate corresponding parts throughout the views of the drawings.

### DETAILED DESCRIPTION OF THE PREFERRED EMBODIMENT

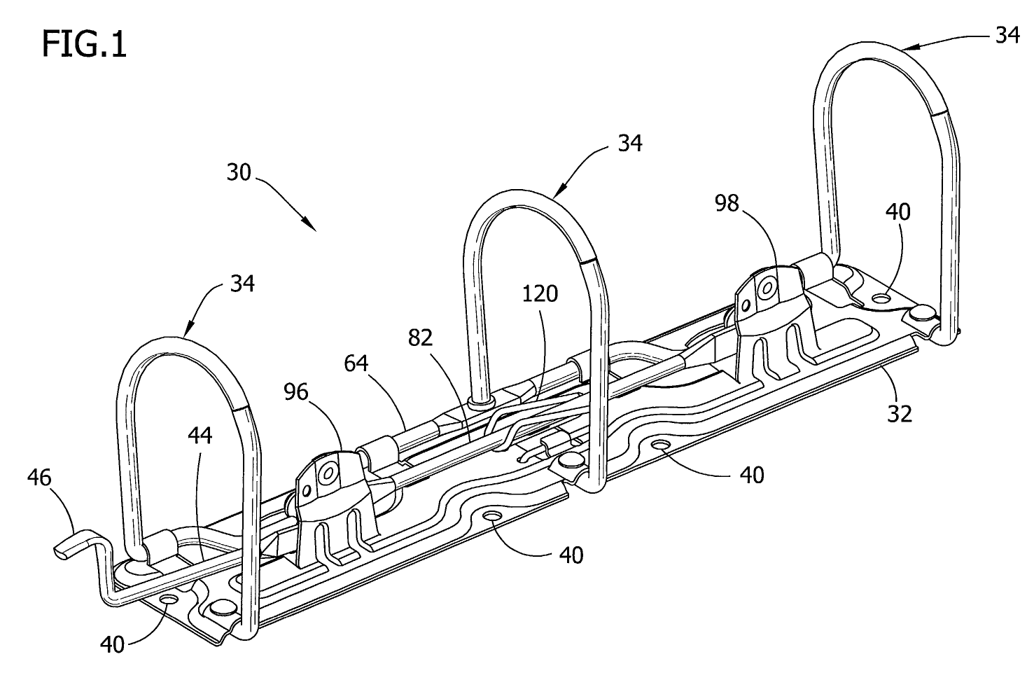

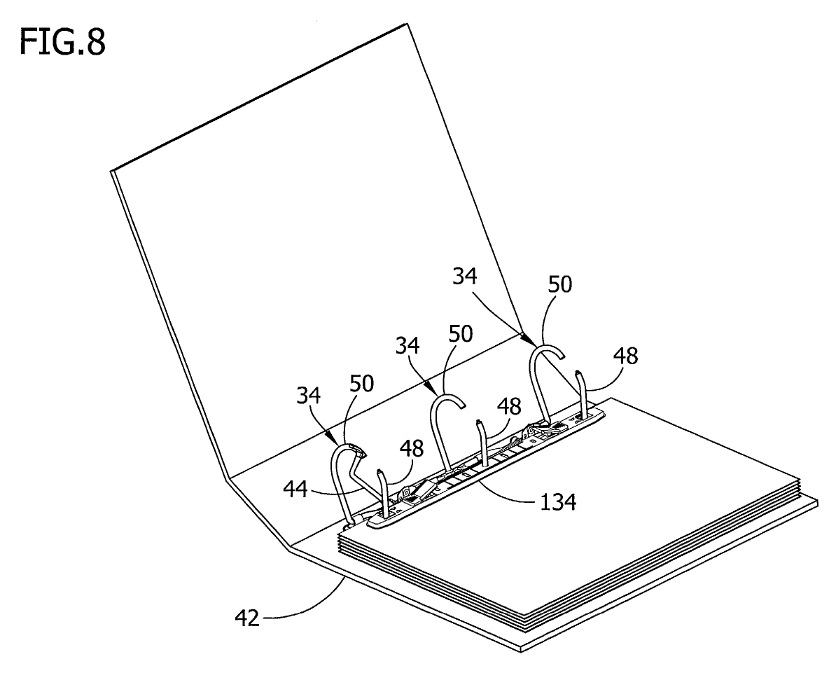

Referring now to the drawings and in particular to FIG. 1, a binder mechanism according to the present invention for retaining loose leaf pages is indicated generally at 30. The mechanism 30 includes a base 32 and three retaining members, each indicated generally at 34, for holding loose leaf pages. The base 32 is thin, substantially flat, and generally shaped as an elongated rectangle with two generally opposite longitudinal edges 36 (FIG. 7) and two generally opposite transverse edges 38. The base 32 is sized suitably large to provide a stable mount for the mechanism 30, while being lightweight to conserve material and manufacturing costs. A width W of the base 32 is defined by a spacing between the longitudinal edges 36. Holes 40 are provided near the edges 36, 38 for receiving fasteners (not shown) to secure the mechanism 30 to a file or notebook 42 (FIG. 8). The base 32 is made of a suitable rigid material, such as steel, which is pressed or stamped to manufacture the base. Mechanisms having bases of other shapes, including irregular shapes, or bases which are integral to a file or notebook, do not depart from the scope of this invention.

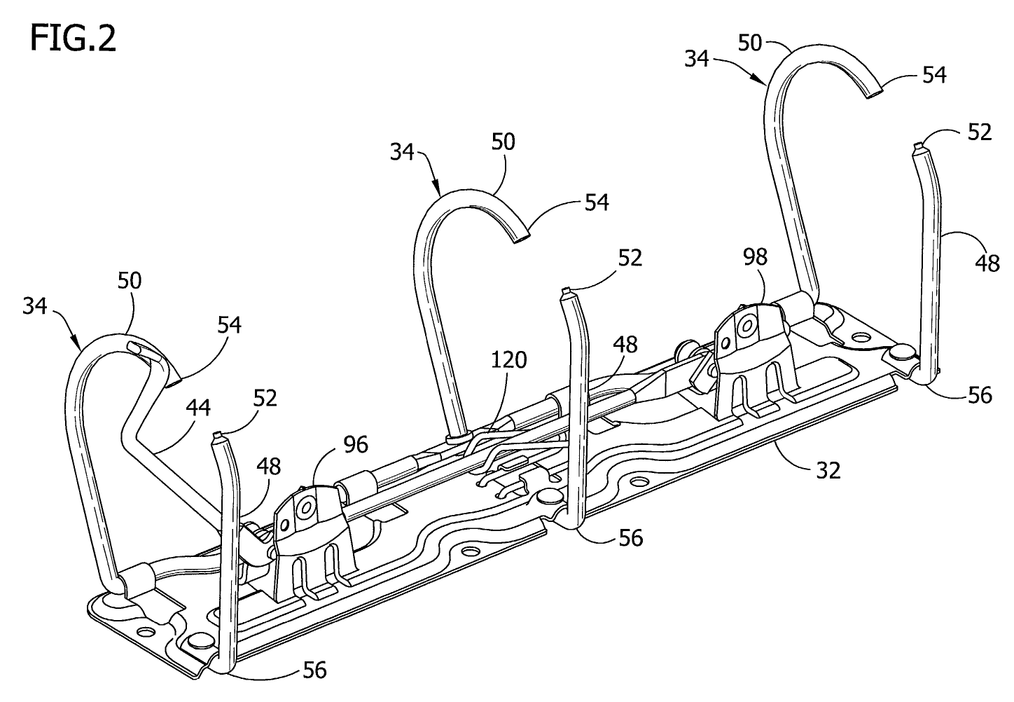

The three retaining members 34 are secured to the base 32 and moveable between a closed position (FIGS. 1, 3, and 6) wherein each retaining member forms a continuous, closed loop for retaining loose leaf pages, and an open position (FIG. 2) wherein each retaining member forms a discontinuous, open loop suitable for adding or removing pages. A lever 44 is provided for selectively moving the retaining members 34 between the open and closed positions. The lever 44 is turned upwardly and thence outwardly at its free end, defining a finger grip 46 for gripping and moving the lever. The retaining members 34 are formed of a conventional, cylindrical rod of a suitable material such as steel. Each retaining member 34 includes a generally straight section, or post 48 (FIG. 2), and an arch section 50. The post 48 is fixed relative to the base 32 while the arch section 50 is pivotally moveable. The post 48 is generally straight to facilitate adding or removing a large stack of papers. A mechanism with a different number of retaining members, greater or less than three, does not depart from the scope of this invention. Further, a mechanism wherein a post is moveable or wherein both post and arch section are moveable does not depart from the scope of this invention.

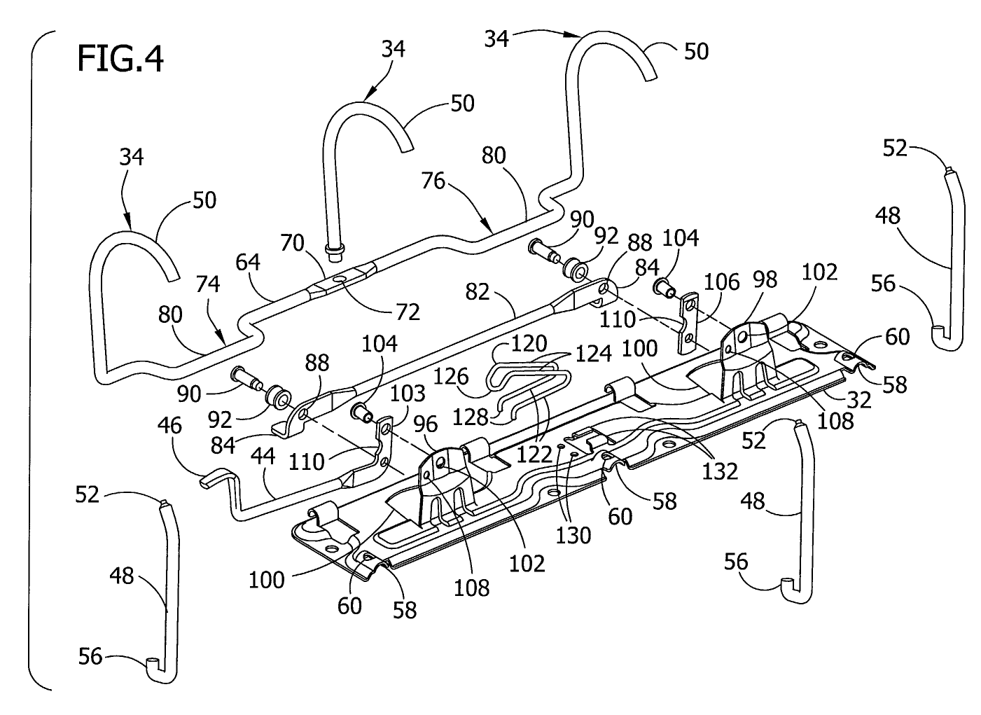

An upper end of the post 48 has a conical profiled tip 52, shown in FIG. 2, which is suitable for alignment and mating engagement with a corresponding recess (not shown) on an end 54 of a corresponding arch section 50. A lower end 56 of the post 48 is secured to the base 32. As seen in FIG. 4, the lower end 56 has a bent or turned portion with two substantially 90 degree bends forming a hook shape. Alternatively, the lower end 56 may have only one 90 degree or no bend (not shown). The lower end 56 is received in an inverted channel 58 and opening 60 (FIG. 4) in the base 32 and secured to the base by a suitable method such as welding, splaying the end after insertion in the opening, or an interference fit.

The arch sections 50 of the retaining members 34 are operatively connected together by a shaft 64 which is pivotable about a pivot axis 66 (shown in FIG. 7) for moving the retaining members between the closed and open positions. The shaft 64 is pivotally secured to the base 32 by four bent over tabs 68 which are aligned along the pivot axis 66. Preferably, the tabs 68 are integral with the base 32. In the illustrated embodiment, the shaft 64 is formed as one piece with the arch sections 50 of the two endmost retaining members, as shown in FIG. 4, and the centermost arch section is formed separately and rigidly fastened to the shaft. The shaft 64 and arch sections 50 may be otherwise formed and connected together without departing from the scope of the present invention. Preferably, the shaft 64 and arch sections 50 are made for conjoint pivoting motion about the pivot axis 66.

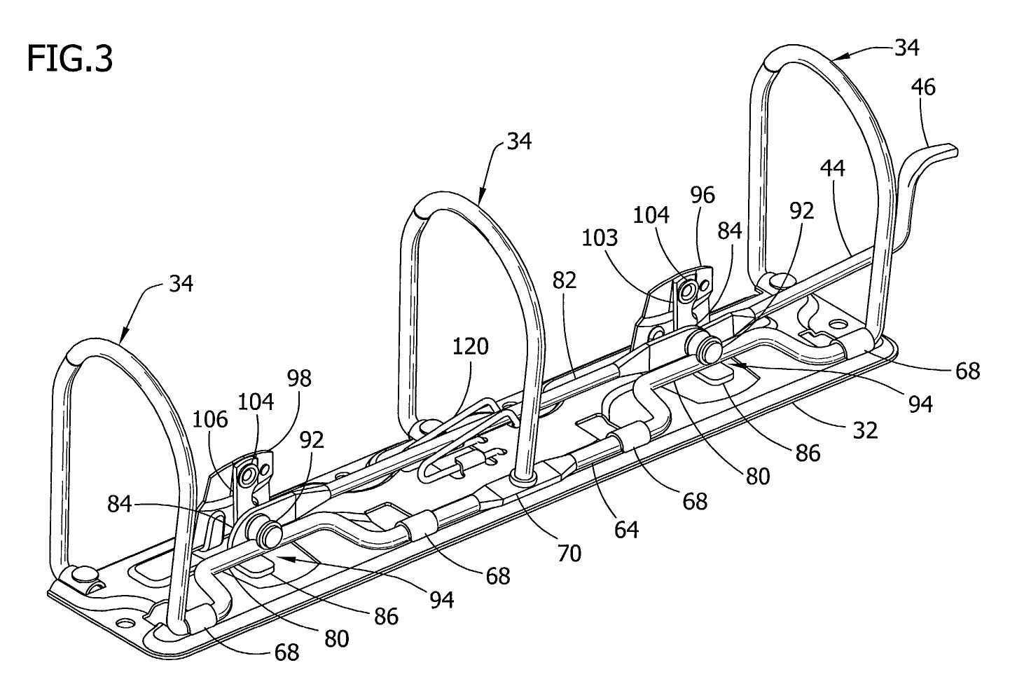

The shaft 64 has a fastening area 70 (FIGS. 3 and 4) suitable for attachment of the centermost arch section 50. The fastening area 70 has a rectangular cross section which is relatively wider and flatter than other, circular portions of the shaft 64. It has a hole 72 therein for receiving an end of the centermost arch section 50, which is fixedly secured by a suitable connection such as an interference fit. The fastening area 70 divides the shaft 64 into first and second similar segments indicated generally on FIG. 4 at 74 and 76, respectively. The first segment 74 is disposed between a first pair of adjacent retaining members 34 and the second segment 76 is disposed between a second pair of adjacent retaining members. Other configurations do not depart from the scope of this invention, including a mechanism having two or more separate shafts 64.

The shaft 64 has first and second crank portions 80, each offset from the pivot axis 66 and generally parallel thereto. Movement of the retaining members 34 between the open and closed positions is accomplished by application of a force on the crank portions 80 in a direction perpendicular to the pivot axis 66, which tends to rotate the shaft 64. Each crank portion 80 is positioned near the center of the width W of the base 32, as shown in FIG. 7, to inhibit deflection of the base arising from asymmetric loading on the base. Further, each crank portion 80 is positioned centrally between two corresponding retaining members 34 so that clamping forces are evenly distributed.

A linking rod, or linkage 82, is pivotally connected to the lever 44 for transferring force from the lever to the shaft 64 for moving the arch sections 50 to the closed position. The linkage 82 is configured to apply a substantially equal force to the crank portions 80 of the first and second segments 74, 76. The linkage 82 has opposite ends 84 in engagement with the crank portions 80 of the shaft 64. Each end 84 includes a flat tab 86 which is oriented generally parallel to the base 32 and which engages a bottom side of the shaft 64, as seen in FIG. 3. Each end 84 of the linkage also has a hole 88 therein (FIG. 4) for receiving a fastener 90 which carries a roller 92 engaging a top side of the shaft 64. The roller 92 has an annular channel which receives a circumferential section of the crank portion 80 and substantially conforms thereto. The tab 86 and roller 92 have a constant spacing therebetween which defines a slot, indicated generally at 94 in FIG. 3, in which a respective crank portion 80 of the shaft 64 is captured. By this arrangement, the linkage 82 and crank portion 80 are constrained to move together in a direction perpendicular to the base 32 (i.e., vertically). However, the linkage 82 is free to move in relative motion along the shaft 64 in a direction parallel to the base 32 (i.e., horizontally) by sliding motion of the tab 86 and roller 92 along the shaft.

First and second generally upright walls 96, 98 of equal height extend from the base 32. Preferably, each wall 96, 98 is formed as one piece with the base 32 to minimize material cost. The wall is stamped out from the base 32 and bent upwardly, leaving an opening 100 in the base, shown in FIG. 4. Each wall 96, 98 has a hole 102 near a top of the wall. On the first wall 96, an end segment 103 of the lever 44 opposite the finger grip 46 is pivotally connected by a rivet 104 received through the hole 102. On the second wall 98, a bar 106 is pivotally connected by another rivet 104 received through hole 102 for pivotal motion relative to the wall. A stop 108 (FIG. 4) is provided on each wall 96, 98 which is engageable by a corresponding recess 110 on the end segment 103 or bar 106 for limiting a relative angle between the end segment or bar, respectively, and the wall. By the pivotal motion of the lever 44 and bar 106, the ends 84 of the linkage 82 are constrained to move simultaneously in identical motion relative to the base 32. Consequently, the linkage 82 is maintained at an orientation parallel to the base 32 while it moves.

A spring 120 is mounted on the base 32 and configured to engage the linkage 82 to apply force to bias the linkage away from the base. The crank portions 80 of the shaft 64 are urged by the spring 120 to pivot away from the base 32 so as to bias the arch sections 50 of the retaining members 34 toward the open position. The spring 120 is bent to have a pair of spaced, parallel legs 122 (FIG. 4) engaging the base 32 and a pair of spaced, parallel arms 124 extending upwardly from the base back over the respective legs. The arms 124 are joined at their upper ends by a U-shaped receiver 126 which receives the linkage 82 between the arms and engages the linkage for transferring the spring force to the linkage. In both the open and closed positions, the arms 124 are deflected toward the legs 122 from their relaxed position so that the spring 120 constantly applies a force against the linkage 82. Downwardly turned feet 128 at the ends of the legs 122 are received through respective holes 130 in the base 32 for use in locating the spring. The legs 122 pass under respective hold downs 132 formed as one piece with the base 32 and extending upwardly over the legs.

Force provided by the spring 120 can be adjusted to meet requirements by replacing the spring with another spring having an increased or decreased diameter of wire. The wire spring 120 provides advantage over leaf type springs in that it precludes any burrs which are often found on leaf springs.

The spring 120 is mounted generally midway between the first and second crank portions 80 of the shaft 64, at a central location on the base 32 wherein distribution of support for the spring is generally midway between the opposite longitudinal edges 36 of the base. Accordingly, forces from the spring 120 do not tend to deflect the base 32 as with mechanisms having a spring mounted toward an edge 36 of the base. Further, the forces applied on the two crank portions 80 of the shaft are substantially equal so that clamping force in the retaining members 34 is equally distributed. The central location of the spring 120 also permits the mechanism to have only one spring, which reduces cost.

In operation, the binder mechanism 30 of the present invention retains loose leaf pages with three retaining members 34 which are linked for conjoint movement and similar clamping forces. The base 32 of the mechanism is secured to a file or notebook 42 in a suitable manner. The lever 44 is moved by grasping the finger grip 46 and lifting upwardly, to move the arch sections 50 to the open position of FIG. 2, and papers are inserted onto the posts 48 of the retaining members. As shown in FIG. 8, a compressor bar 134 is preferably placed above the loose leaf pages to prevent the pages from riding up on the retaining members. Suitable compressor bars 134 are described in European Patent Publications No. EP0928700 and EP0941870.

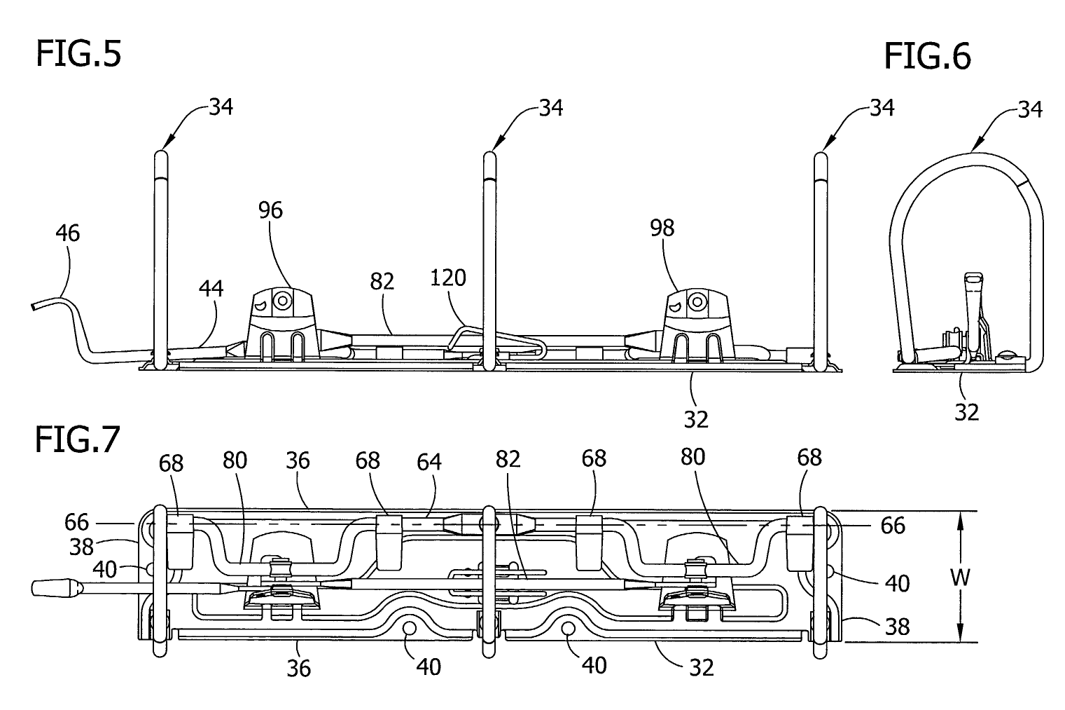

The spring 120 applies upward force to the linkage 82 which, through the tabs 86, pushes upwardly on the crank portions 80 of the shaft 64 to bias the three retaining members 34 to the open position. In opposition to the spring, the lever 44 controllably pivots the shaft 64 toward the base 32 so that the retaining members move to the closed position. The finger grip 46 is moved downwardly to a locked position, shown in FIGS. 1 and 5, where the retaining members 34 are closed. Thus the lever 44, linkage 82, and spring 120 together function as a control for selective movement of the arch sections 50 and positioning of the retaining members. The shaft 64 is controllably pivoted between the open and closed positions, the control applying a force to the first segment 74 via engagement with the first segment at a first crank portion 80 and applying a force to the second segment 76 via engagement with the second segment at a second crank portion.

As the finger grip 46 is moved downwardly, the lever 44 pivots about the rivet 104 on the first wall 96 such that the fastener 90 and roller 92 thereon move in an arc-shaped path. The roller 92 presses down on the crank portion 80 of the shaft 64 to rotate the shaft about the pivot axis 66 and move all three arch sections 50 to the closed position. Simultaneously, the roller 92 and tab 86 slide longitudinally along the shaft 64. The motion at the second segment 76 is substantially identical and simultaneous with that at the first segment 74, with the bar 106 moving in an arc-shaped path. When the lever 44 is down to the locked position, the bar 106 and end segment 103 of the lever are approximately at a perpendicular orientation relative to the base 32 (i.e., vertical). At that position, force from the spring 120 acts in a direction which is longitudinally aligned with the respective bar 106 or end segment 103 and in alignment with the rivet 104, so that the spring does not apply a torque to the linkage 82, or applies a torque which tends to pivot the linkage toward the closed position. Consequently, the mechanism remains in the locked position until the finger grip 46 is lifted.

Because the shaft 64 is pressed downwardly in a generally symmetric arrangement on both segments 74, 76 of the shaft, the clamping force is well distributed and substantially equal in the three retaining members 34. The central location of the spring 120 permits the use of only one spring with balanced force on the shaft 64 and inhibits structural deformation of the base 32.

A method according to the present invention links the centermost retaining member of the three retaining members 34 to the binder mechanism 30. The method includes the step, during manufacture or assembly of the mechanism, of attaching an arch section 50 of the centermost retaining member to the shaft 64 at the fastening area 70 such that the attachment is positioned along the pivot axis 66 and between the two outermost retaining members 34. The post 48 of the centermost retaining member 34 is attached to the base 32 at a position corresponding to the arch section such that the arch section is moveable to clamp against the post. When it is being used, an operator applies substantially equal torques to the shaft 64 at two locations on the shaft (at the first and second segments 74, 76) and thereby pivots the shaft and simultaneously moves all three arch sections 50 between the open and closed positions. The application of torques is accomplished by applying force on the crank portions 80, and it distributes substantially equal forces among the three retaining members for clamping and opening the arch sections from the posts. Other methods of applying torques do not depart from the scope of this invention.

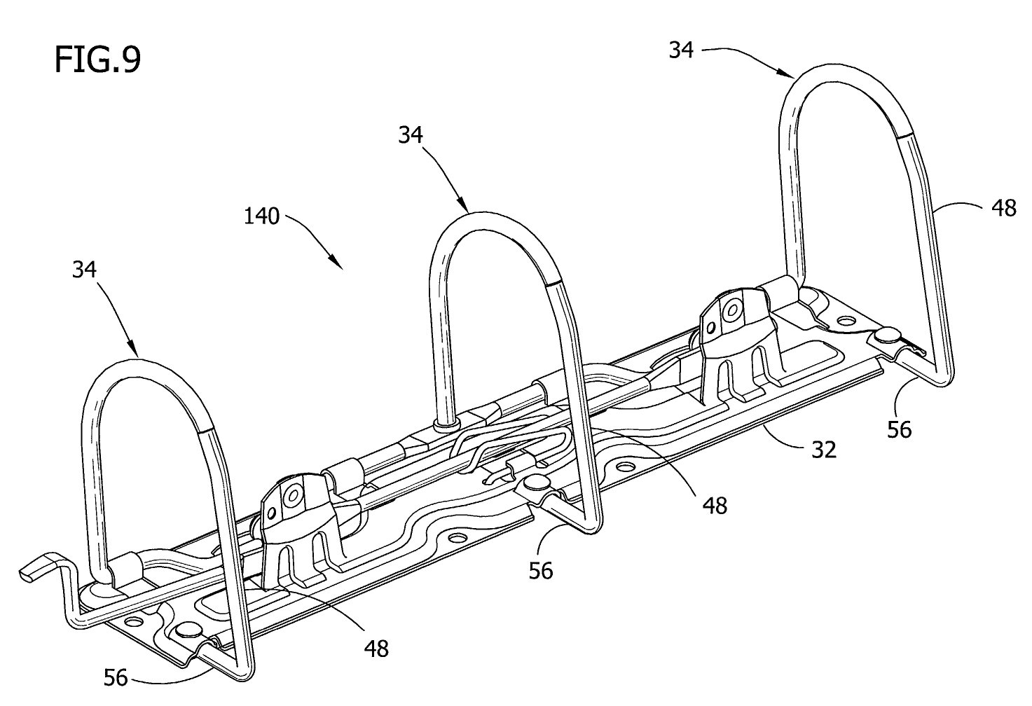

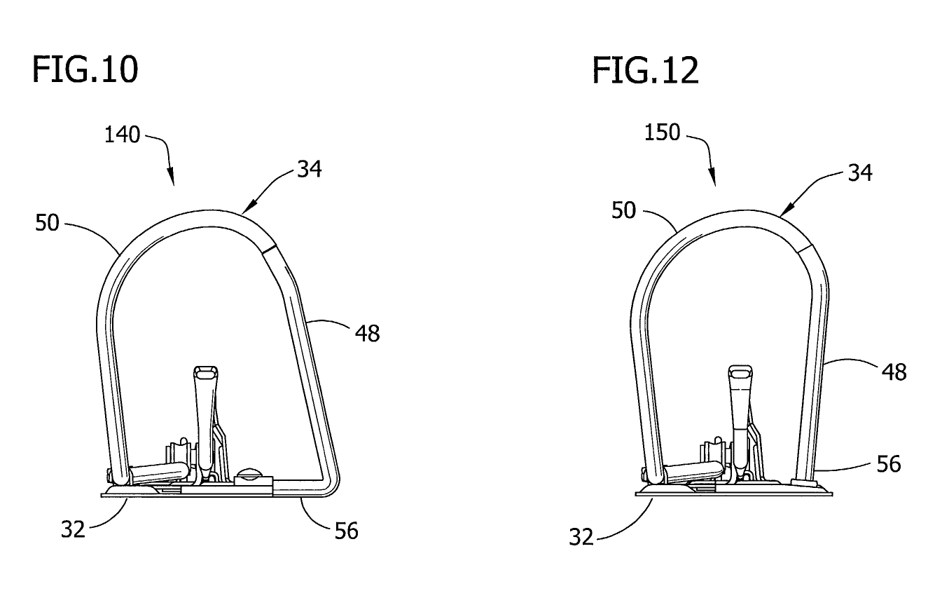

A second embodiment of the mechanism is shown in FIGS. 9 and 10 and indicated generally at 140. The posts 48 of the second embodiment 140 are inclined inwardly from the vertical direction, having a lower end 56 which extends generally horizontally from the base 32 a greater distance than the first embodiment 30 to form a wider retaining member. The second embodiment 140 provides the advantage of an increase in quantity of paper which may be retained, and permits the base 32 to be narrower to reduce material costs.

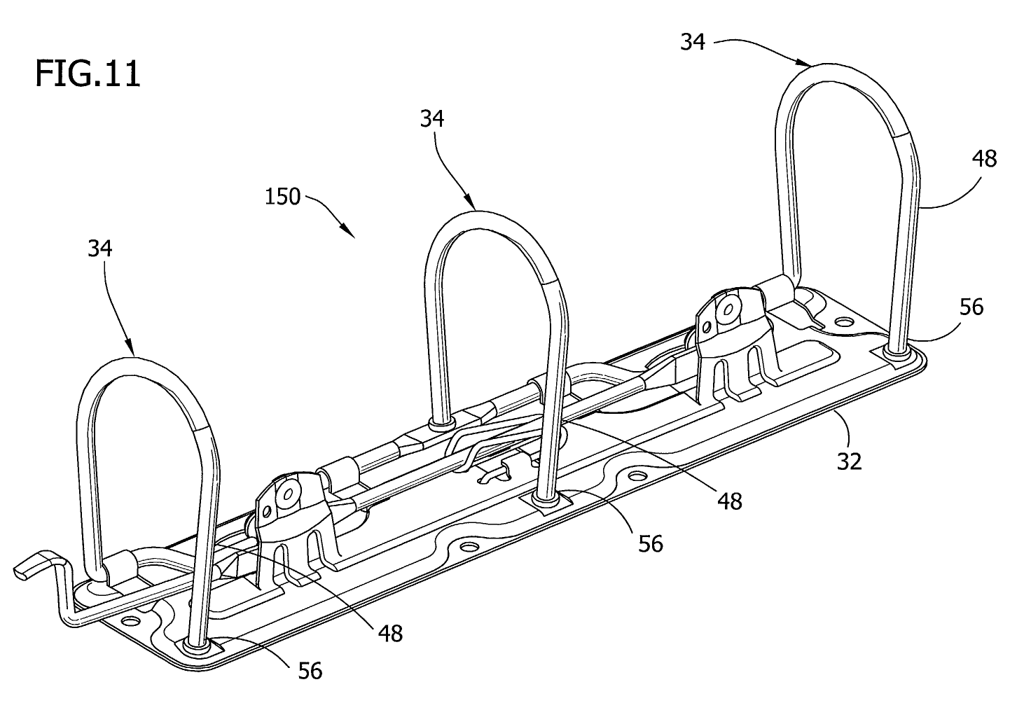

A third embodiment of the mechanism is shown in FIGS. 11 and 12 and indicated generally at 150. The posts 48 of the third embodiment 150 are inclined slightly outwardly from the vertical direction, each having a straight lower end 56 which is directly connected to the base 32 without a bent end. The third embodiment 150 provides the advantages of easier manufacturing and a slight increase in quantity of paper which may be retained, relative to the first embodiment 30. However, it can require a wider base 32 in order to ensure a stable mount on the file or notebook.

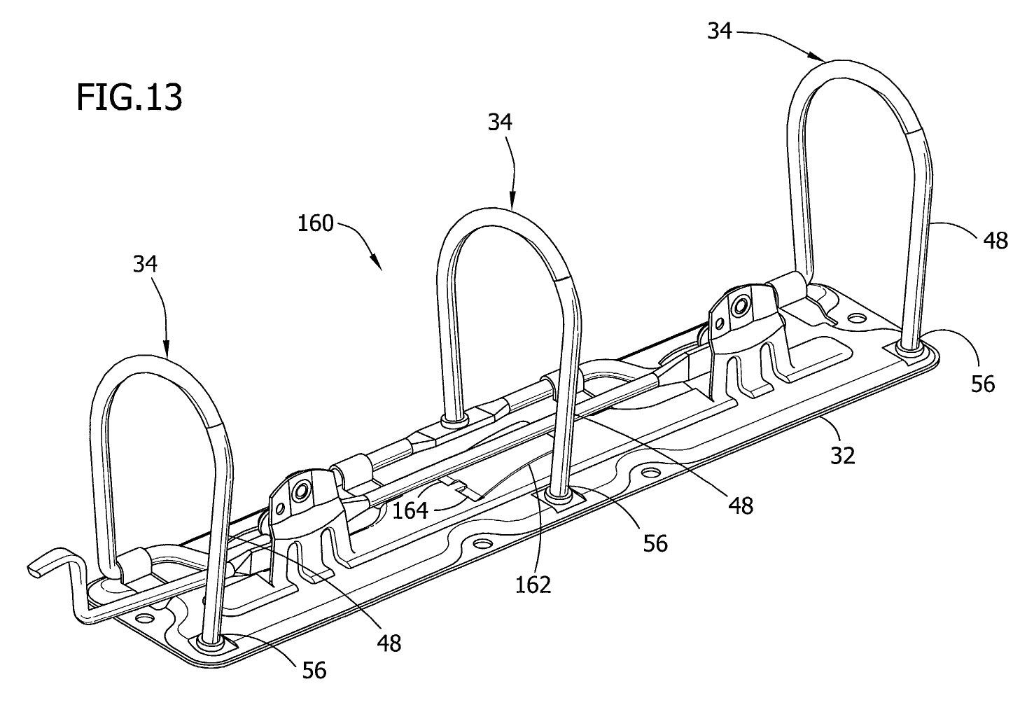

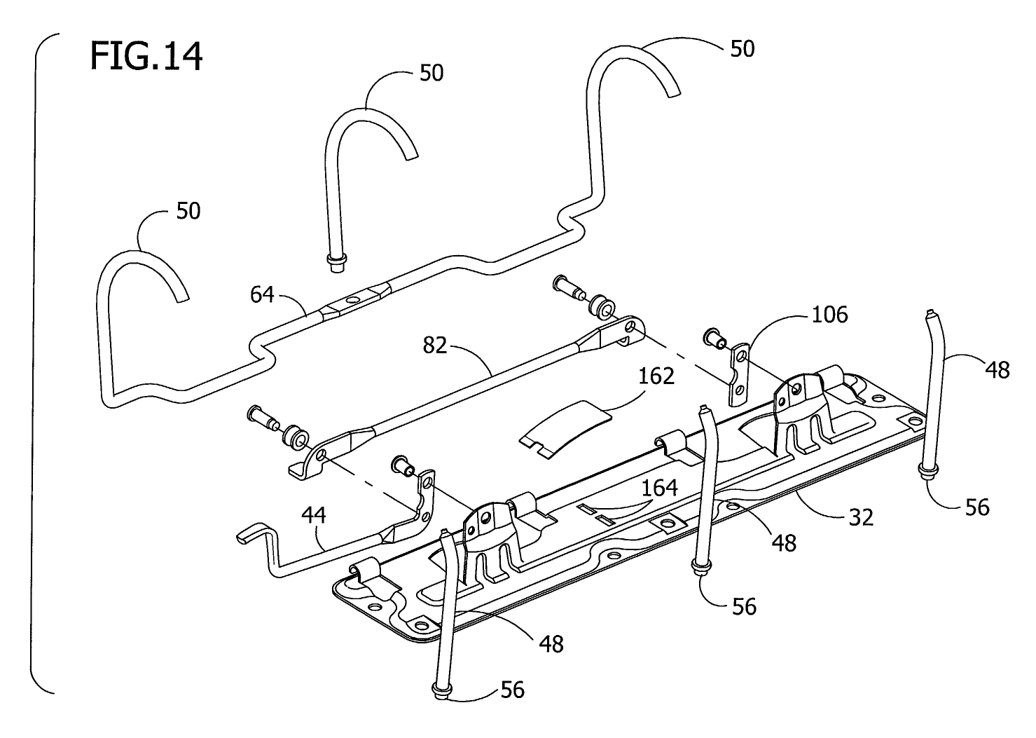

A fourth embodiment of the mechanism is shown in FIGS. 13 and 14 and indicated generally at 160. A spring 162 of the fourth embodiment 160 is a leaf spring, which is secured in a slot 164 on the base 32. An advantage is that the leaf spring 162 is easier to manufacture than the formed wire spring 120 of the first embodiment. Force provided by the spring 162 can be adjusted to meet requirements by increasing or decreasing a thickness of the leaf, or by varying the length or width dimension of the leaf as necessary. The posts 48 of the fourth embodiment 160 may be vertical, inclined inwardly, or inclined outwardly, similar to the posts of the first, second, and third embodiments, respectively. The lower end 56 of the post may be directly connected to the base 32 (as shown) or have a bent end and received in an inverted channel in the base as in the first embodiment.

In view of the above, it will be seen that the several objects of the invention are achieved and other advantageous results obtained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A binder mechanism for retaining loose leaf pages, the mechanism comprising:
a base;
at least three retaining members secured to the base for holding said loose leaf pages, the retaining members being moveable between a closed position wherein each retaining member forms a substantially continuous, closed loop for allowing loose leaf pages retained by the retaining members to be moved along the retaining members, and an open position wherein each retaining member forms a discontinuous, open loop suitable for adding or removing said loose leaf pages;
a shaft mounted on the base for pivoting about a pivot axis and mounting said retaining members for moving the retaining members between the closed and open positions, the shaft having a first segment and a second segment; and
a control for controllably pivoting the shaft between the open and closed positions, the control applying a force to the first segment via engagement with the first segment and applying a force to the second segment via engagement with the second segment.

2. A binder mechanism as set forth in claim 1 wherein the control engages the first segment at a first location and engages the second segment at a second location.

3. A binder mechanism as set forth in claim 2 wherein the control comprises a lever pivotally mounted on the base for actuating movement of the shaft, and a linkage mounted on the base and operatively connected to the shaft for transferring force applied by the lever to the first and second locations.

4. A binder mechanism as set forth in claim 3 wherein each of said first and second segments of the shaft have a crank portion which is spaced from said pivot axis of the shaft.

5. A binder mechanism as set forth in claim 4 wherein said linkage engages the crank portions of the first and second segments of the shaft.

6. A binder mechanism as set forth in claim 5 wherein the crank portions are slidably captured in slots formed at ends of said linkage.

7. A binder mechanism as set forth in claim 1 wherein said first and second segments of the shaft are integral.

8. A binder mechanism as set forth in claim 1 further comprising a spring for biasing the retaining members to the open position.

9. A binder mechanism as set forth in claim 8 wherein said spring is mounted on the base and configured to engage the linkage.

10. A binder mechanism as set forth in claim 9 wherein said spring is positioned generally midway between said first and second crank portions.

11. A binder mechanism as set forth in claim 1 wherein each of said retaining members includes a portion fixed relative to the base and a portion moveable relative to the base.

12. A binder mechanism as set forth in claim 1 in combination with a notebook, the notebook comprising a cover including two side panels and a spine, the mechanism being secured to the cover.

13. A binder mechanism for retaining loose leaf pages, the mechanism comprising:
an elongate base having a width defined by two generally opposite longitudinal edges;
a plurality of retaining members secured to the base for holding said loose leaf pages, the retaining members being moveable between a closed position wherein each retaining member forms a continuous, closed loop for allowing loose leaf pages retained by the retaining members to be moved along the retaining members, and an open position wherein each retaining member forms a discontinuous, open loop suitable for adding or removing said loose leaf pages;
a shaft mounted on the base for pivoting about a pivot axis and mounting said retaining members for moving the retaining members between the closed and open positions, the shaft having at least one crank portion which is spaced from the pivot axis; and
a spring for resiliently transmitting force between the base and said crank portion of the shaft and for biasing the retaining members to the open position, the spring being mounted on the base at a location generally midway between said opposite longitudinal edges of the base whereby force is applied generally symmetrically relative to the width to thereby inhibit structural deformation of the base.

14. A binder mechanism as set forth in claim 13 in combination with a notebook, the notebook comprising a cover including two side panels and a spine, the mechanism being secured to the cover.

15. A binder mechanism for retaining loose leaf pages, the mechanism comprising:
a base;
three retaining members secured to the base for holding said loose leaf pages, the retaining members each having a post in fixed position relative to the base and an arch section moveable relative to the base between a closed position wherein each retaining member forms a substantially continuous, closed loop for allowing loose leaf pages retained by the retaining members to be moved along the retaining members, and an open position wherein each retaining member forms a discontinuous, open loop suitable for adding or removing said loose leaf pages;
a shaft mounted on the base for pivoting about a pivot axis and mounting said arch sections for moving the arch sections between the closed and open positions, the shaft having a first segment and a second segment, each segment being positioned between a respective pair of retaining members and each having a crank portion which is spaced from said pivot axis of the shaft;
a lever pivotally mounted on the base for actuating movement of the shaft;
a linkage operatively connected to the lever and in engagement with said crank portions of the shaft for transferring force applied by the lever to the first and second segments of the shaft, the linkage having first and second slots formed at opposite ends of the linkage, said crank portions of the first and second segments being slidably captured in respective slots; and
a spring for biasing the arch sections to the open position, the spring being mounted on the base at a position generally midway between said crank portions of the first and second segments and configured to engage the linkage.

16. A method of linking a third retaining member to a binder mechanism having first and second retaining members for holding loose leaf pages, the mechanism having a base and a shaft mounted on the base for pivoting about a pivot axis, each of the first and second retaining members having a post secured to the base and an arch section secured to the shaft, the arch sections being moveable between a closed position wherein each arch section clamps against the corresponding post and the retaining member forms a continuous, closed loop, and an open position wherein each arch section is spaced from the corresponding post and the retaining member forms a discontinuous, open loop, the method comprising the steps of:
attaching an arch section of said third retaining member to said shaft at a location along said pivot axis and between said first and second retaining members;
attaching a post of said third retaining member to said base at a position corresponding with said arch section of the third retaining member; and
applying substantially equal torques to said shaft at two locations on said shaft and thereby pivoting the shaft and simultaneously moving the first, second, and third arch sections between the open and closed positions, said locations being spaced on opposite sides of said third retaining member and arranged between said first and second retaining members such that application of said torques distributes substantially equal forces among first, second, and third said retaining members for clamping and opening the arch sections.
